(19) United States
(12) Patent Application Publication
(10) Pub. No.: US 2009/0259928 A1
(43) Pub. Date: Oct. 15, 2009

(54) SYSTEMS AND METHODS FOR EMPLOYEE COMPENSATION PLANNING

(76) Inventor: Terrance L. Lillie, Emerald Hills, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/417,609

(22) Filed: Apr. 2, 2009

Related U.S. Application Data
(60) Provisional application No. 61/042,223, filed on Apr. 3, 2008.

(51) Int. Cl. G06F 17/00

(52) U.S. Cl. 715/205

(57) ABSTRACT

Systems, methods, graphical user interfaces (GUIs), and computer readable media for providing information related to a compensation plan for an enterprise. A view of a portion of a compensation plan developed by a compensation planning application is presented and includes a hyperlink. The hyperlink is associated with information related to the compensation plan, but stored separately from the compensation planning application, for example as part of a global rewards library. In response to receipt of a selection of the hyperlink, a view of the information associated with the hyperlink is provided.

### RELATED APPLICATION

This application is a Non-Provisional of, incorporates by reference in its entirety, and hereby claims the priority benefit of U.S. Provisional Patent Application No. 61/042,223, entitled “Systems and Methods for Employee Compensation Planning”, filed 3 Apr. 2008 by the present inventor and assigned to the assignee of the present invention.

### FIELD OF APPLICATION

The present application relates to platforms configured to provide information related to a compensation plan for workforces that may be made up of large numbers of geographically dispersed employees.

### BACKGROUND

Although there are several existing solutions that are marketed under the guise of compensation planning software or systems, these solutions tend to be very expensive to implement and difficult to configure and maintain. This is perhaps not surprising, inasmuch as compensation planning for a global workforce is a complex problem. The variety and dynamic character of government-mandated and company-imposed rules for employee compensation virtually necessitate complex solutions.

Given the complex nature of the problem, to date most compensation planning providers have developed applications that are specifically configured to the needs of their clients. Such solutions tend to offer limited functionality and, when needs vary from client to client, or when they change from year to year or by geographic region, the clients must return to the providers for software reprogramming, application updates and reconfigurations. This process is both time consuming and expensive.

In general then, this “hard-wired” approach to compensation planning systems is inherently self-limiting because the business either imposes severe restrictions on the client base or the many implementations approach simply will not scale efficiently for the developer.

Additionally, compensation factors or benefits for an employee or group of employees may vary by, for example, geographic region such that a user in one geographic region does not understand a compensation factor or benefit paid to an employee in another geographic region. Consequently, what is needed are improved systems and methods for providing information related to a compensation plan.

### SUMMARY

Systems, methods, graphical user interfaces (GUIs), and computer readable storage media for providing information related to a compensation plan for an enterprise are provided. An application for compensation planning may be opened. A view of a portion of the compensation plan may be provided via, for example, the application. The view may include a hyperlink and the hyperlink may be associated with information related to the compensation plan. The information associated with the hyperlink may be related to, for example, a compensation benefit provided by the compensation plan. Selection of the hyperlink may then be received and a view of the information associated with the hyperlink may be provided. The information associated with the hyperlink may be provided via, for example, a view, a message, an email, and an instant message. In some cases, the information associated with the hyperlink may be searchable.

In some embodiments, the view of the information associated with the hyperlink may be capable of receiving data. Data, which may be retrieved from an application or data source separate from the compensation planning application (e.g., from a global rewards library) via a Web service interface or other means, may then be received in the view. The information associated with the hyperlink may then be updated using the received data. Additionally or alternatively, the compensation plan may be updated using the received data.

In one embodiment, the information related to the compensation plan may be updated, for example, periodically or as needed. In some cases, the information may be stored in a database and the database may be searched for the information. In some cases, it may be determined whether a user is be allowed to access the information based on, for example, one or more security parameters.

### BRIEF DESCRIPTION OF THE DRAWINGS

The present invention is illustrated by way of example, and not limitation, in the figures of the accompanying drawings, in which:

FIG. 1 illustrates an example of a system enabled to validate a compensation plan of an enterprise, consistent with embodiments of the present invention;

FIG. 2 illustrates an example of a software architecture for a compensation planning application configured in accordance with an embodiment of the present invention, consistent with embodiments of the present invention;

FIGS. 3A-B illustrate examples of planning pages through which a manager or other individual responsible for planning compensation of others can view information relevant to that process;

FIG. 4 illustrates an example of a page of information concerning a particular compensation benefit as retrieved from a database;

FIG. 5 illustrates a process for providing information related to a compensation plan of an enterprise, consistent with embodiments of the present invention;

FIG. 6 illustrates a process for receiving data related to a compensation plan of an enterprise, consistent with some embodiments of the present invention; and

FIG. 7 illustrates a process for providing information related to a compensation plan of an enterprise, consistent with embodiments of the present invention.

### DESCRIPTION

Described herein are systems, computer readable media, and methods to facilitate total compensation package planning for workforces that may be made up of large numbers of geographically dispersed employees. In one embodiment, the present invention is instantiated as a configurable, computer-based application that supports variability in compensation planning rules and data representation without requiring that the application be reprogrammed. This flexibility permits users of the computer-based application to update or revise methodologies used for compensation planning (e.g., in response to company-based initiatives or government-mandated regulations for particular jurisdictions) as needed.

As will be apparent from the description below, various embodiments of the present invention may be implemented with the aid of computer-implemented processes or methods (a.k.a. programs or routines) that may be rendered in any computer language. As an example, certain modules that comprise one instantiation of the present invention may be written in a compiled language, such as Java™ or the like. Moreover, some portions of this detailed description that follow are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a programmed computer system, or similar electronic computing device, that manipulates and transforms data represented as physical (electronic) quantities within the computer system's registers and memories into other data similarly represented as physical quantities within the computer system memories or registers or other such information storage, transmission or display devices.

Where embodied as computer-readable instructions, the present application may be executed on or by a computer system. In such instances, the application may reside as a computer program stored in a computer readable storage medium, such as, but not limited to, any type of disk including floppy disks, optical disks, CD-ROMs, and magnetic-optical disks, read-only memories (ROMs), random access memories (RAMs), electrically programmable ROMs (EPROMs), electrically erasable programmable ROMs (EEPROMs), flash memories, magnetic or optical cards, or any type of media suitable for storing electronic instructions. The algorithms and processes presented herein are not inherently related to any particular computer or other apparatus.

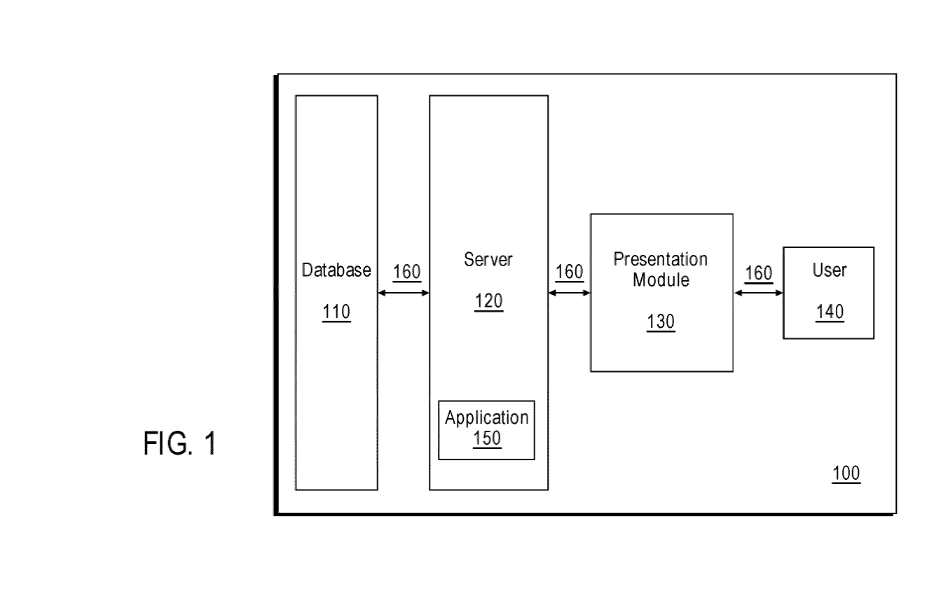

FIG. 1 illustrates an example of a system 100 for implementing a compensation planning software application. System 100 may include a database 110, an application server 120, a presentation module 130, a user 140, an application 150 and communication links 160. Database 110 may include actual data (e.g., employee names, compensation data, etc.) for an enterprise and may be maintained by, for example, the enterprise or another entity at the direction of the enterprise. Database 110 may be resident on, for example, server 120 or an external memory device, such as a disk drive. Server 120 may be any software application server, such as IBM's™ WebSphere Application Server™ (WAS), Red Hat's JBoss™ application server, etc. and presentation module 130 may be, for example, a computer system configured with a web browser such as Microsoft's™ Internet Explorer™. User 140 may be any user of system 100, such as an executive, manager, and/or employee of an enterprise. Application 150 may be, for example, an application for compensation planning and may be resident in, for example, a server, such as server 120. Communication links may be any appropriate means of facilitating communication between the components of system 100, such as wired and/or wireless communication links.

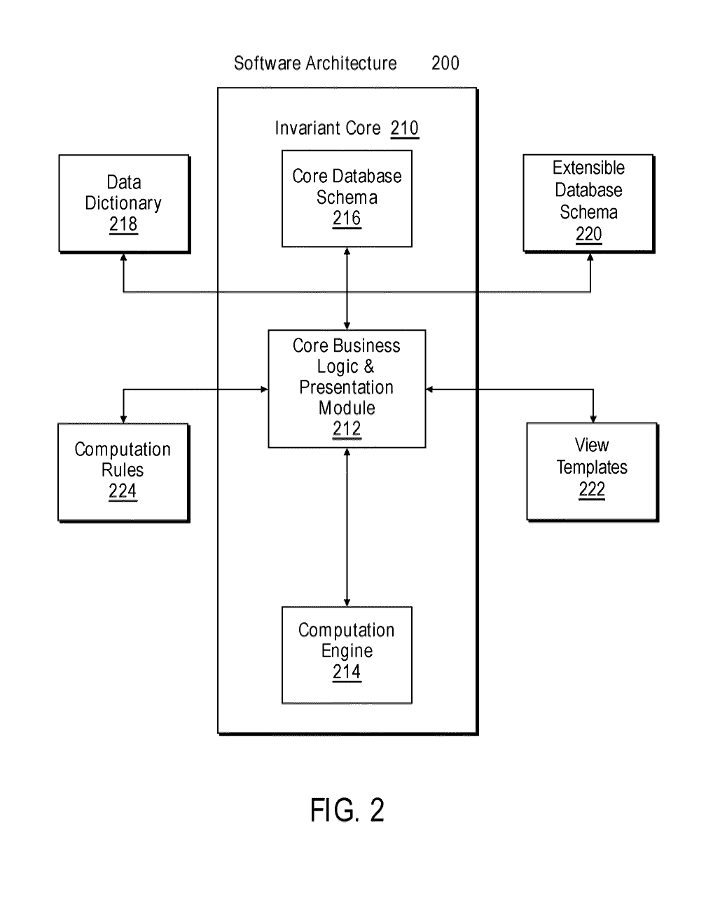

FIG. 2 illustrates an example of a software architecture 200 for an application configured in accordance with an embodiment of the present invention. Application 200 may be installed on server 120 and accessible to user 140 via presentation module 130. As shown, a modularized approach is used so that the overall application is made up of certain modules comprising an invariant core 210 of the application, and other dynamic modules which are highly customizable. The modules that make up the invariant core of the application may include a core business logic and presentation module 212, a computation engine module 214 and/or a core database schema module 216. The dynamic modules of this architecture may include a data dictionary module 218 (which may be memory resident when the application is executing on a computer system such as server 120), an extensible database schema module 220, a view templates module 222, and a computation rule module 224. This modularized approach to software implementations of the present compensation planning system allows for a wide variety of user-specific implementations without the need to reprogram vast libraries of, for example, business rules, presentation formats, and other elements thereof. Not shown in this illustration is a database, such as database 110, that stores the actual data (e.g., employee names, compensation data, etc.) for an enterprise, but those of ordinary skill in the art will appreciate that such a database exists and is made accessible to the application during run time.

In some implementations, the dynamic ones of the different software modules are represented in text-based, extensible markup language (XML) form. In such instances, unique implementations of the software application can then be created by editing a set of XML templates that define, for example:

a. user-specific data elements;

b. application calculations (e.g., validation rules);

c. compensation plan descriptions; and/or

d. user-facing data representations (i.e., view templates).

These XML templates may be configured through an administrative user interface that abstracts the complexity of the configuration details from the user. This allows for a high level of configurability with respect to the rules and data representations governing a particular enterprise's compensation planning process without introducing significant complexities to the actual programming task.

As shown in the illustration, at the heart of the software architecture lies the core business logic and presentation module 212. This module is responsible for manipulating the user data according to a defined rule set for compensation planning. While some of these rules (e.g., those which are applicable to any, or virtually any, enterprise) may be specified as part of the application's invariant core (which encompasses application logic that is common to all instantiations of the application, i.e., those portions of the application which are enterprise agnostic, and/or provides functionality common to all such instantiations and that is used as a basis for performing customizations, e.g., a compensation engine), many such rules will be enterprise-specific and so can be specified as part of the computation rule module 224. That is, the core business logic module 212 may be configured to draw upon enterprise-specified rules described in the computation rules module 224 in order to produce results that comply with that enterprise's policies for compensating its employees. Further, customary, local, regional, national and/or other governmental rules pertaining to a compensation package of an employee of an enterprise can be specified as part of either the extensible compensation rule module 224 or data dictionary 21 and, hence, can be customized for an enterprise's needs.

The core business logic and presentation module 212 may include presentation rules applicable to or desirable for any (or virtually any) enterprise. These presentation rules may define how data is formatted and/or presented to users for use in the compensation planning process. The presentation rules may make use of detailed view templates to prepare a planning page to be displayed to a user.

The view template module is configured to process the view templates to facilitate formatting and display of data defined by the data dictionary module. For example, the view template module may read the view templates, retrieve associated data described by the data dictionary module and produces display objects for the presentation module.

View templates may be specified by a configurable view template module 222. Such view templates may be organized by business unit, country, page identifier, porlet identifier, view identifier or other criteria. Default view templates may be made available in the event a specific view that does not match any of these criteria is required. In some embodiments, this scheme is extensible so that if there is a need for different views for job families, e.g., executive managers versus salaried employee managers that need can be accommodated. Templates that are differentiated by any indicator field in the demographic input file (usually generated by the end user's enterprise resource planning system) can be created.

The core business logic and presentation module 212 may make use of computation engine module 214 to perform calculations specified by computation rules for compensation planning. As indicated above, the actual compensation rules may be stored in the data dictionary 218. By specifying the computation rules separate from the computation engine itself, the present system allows for a high degree of customization on a per-user (i.e., per-enterprise) basis.

The compensation rules may be derived from national, regional or local statutory or other governmental requirements, as well as other sources (for example, recognized “best practices” within a given industry may be expressed as compensation rules within the present compensation planning system). As such, the rules are subject to and can be changed over time (for example, as statutory schemes are revised or amended, as an enterprise adopts new policies or procedures, or as industry best practices evolve to accommodate new circumstances or business organizations). The rules may be expressed as equations (to be evaluated by the computation engine) and stored in the data dictionary, for example as strings that define a series of arithmetic and/or conditional operations. Such strings may be stored within appropriate fields of tables that comprise the data structure of the data dictionary.

The computation engine module 214 may include algorithms to compute various results, as directed by the various computation rules. During a planning cycle, as a user makes modifications to some variables, the computation engine module 214 may automatically make modifications to other variables affected by the user inputs and those changes may be reflected via one or more views provided by presentation module 130. Generally, such computations are run against data stored in the database 110 and the data dictionary 218 is used to assign variable names to each field and to identify a location in the database where the corresponding data element can be found.

Of course, the core business logic and presentation module 212 generally operates on user-supplied data that arrives at the module in an expected format. The rules defining that format are specified in the core database schema 216 and/or the extensible database schema 220. More specifically, these schemas collectively define the various tables which store the user data, fields in each of these tables, and relationships between those fields and tables. User data may be stored in and/or retrieved from a database, such as database 110.

In some instances, data dictionary 218 may be an XML file that contains mappings between variable names, database fields and calculation equations. However, defining the data dictionary in such a fashion tends to be somewhat unwieldy. Accordingly, it may be preferable to instead construct the data dictionary using a data dictionary editor.

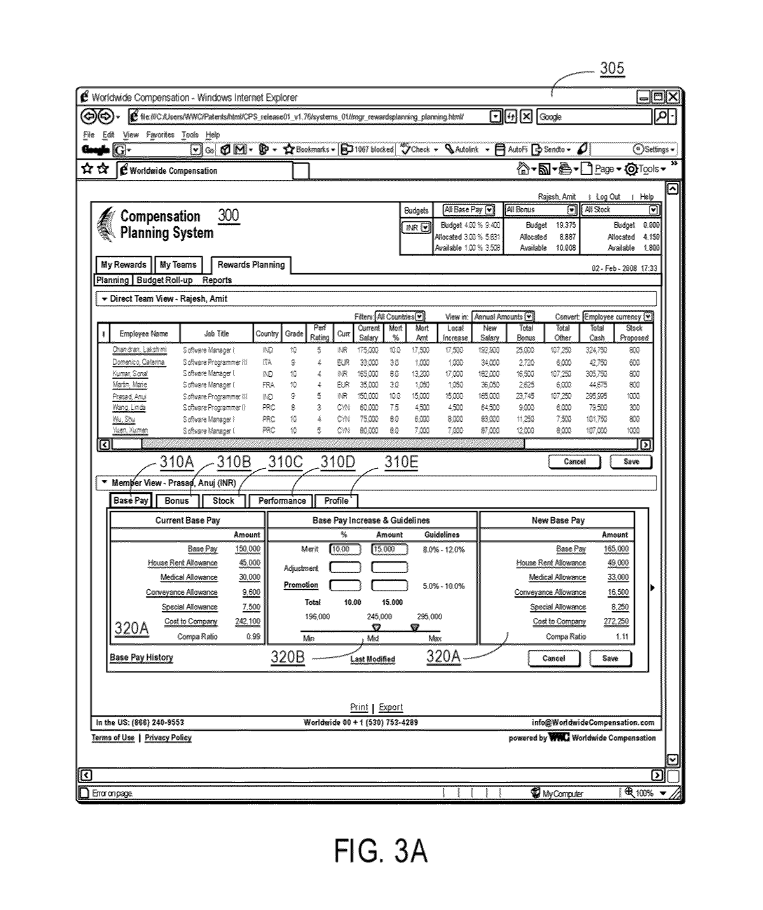

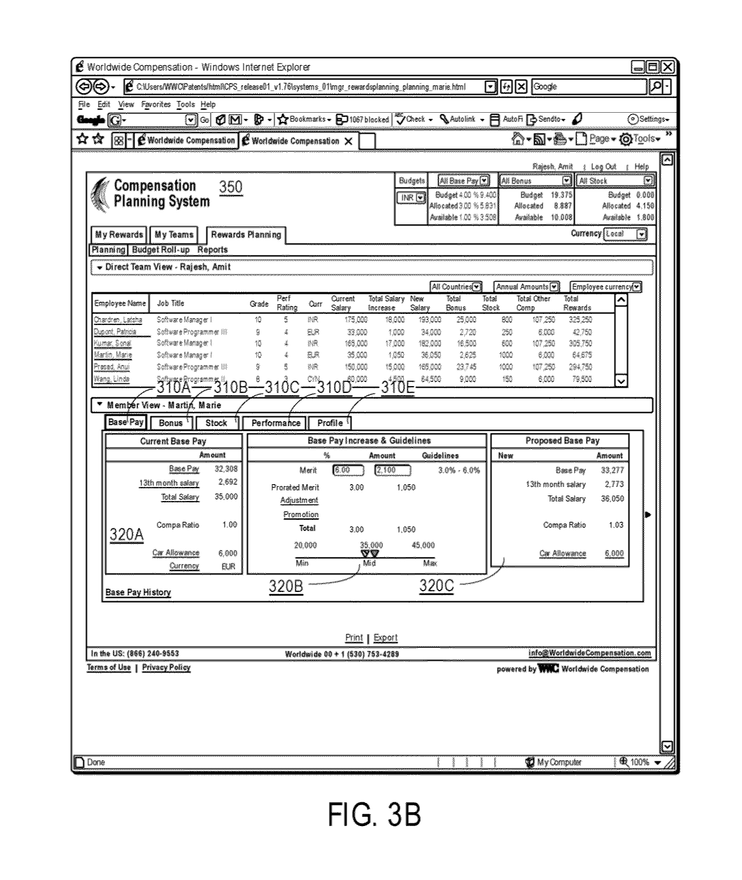

Having thus examined the overall architecture of a software application that provides compensation planning facilities in accordance with an embodiment of the invention, we turn to various aspects of the application in greater detail. We begin with the view templates. These templates may be used to create a planning page, examples of which are shown in FIGS. 3A and 3B, and are the means by which users may interact with the rules and processes for determining compensation packages for employees within an enterprise and access information related to a compensation plan. The examples set forth in FIGS. 3A and 3B show a particular planning page 300 and 350, respectively, displayed within a browser window 305. Thus, it should be apparent that some instantiations of the present application may be run as server-hosted applications accessible through a conventional web browser, although this is not a requirement of the present invention. In other instances, dedicated client applications may be used to present the various views.

The view templates and planning pages may allow the present compensation planning application to represent data in such a way that employee compensation information may be configured, for example, by business unit, geographic region, or both. Because different users, managers, and others with responsibility for compensation planning within an organization may have need for different data representation requirements, the specification of the view templates may be left to a configurable module that exists outside of the invariant core of the application. In one example, the view templates are instantiated as XML representations of client-facing dynamic hypertext markup language (HTML) components, such as datagrids and rollbars, which representations are used to build these elements dynamically at planning page generation time. The generation of a specific dynamic HTML component may then be structured by the view template conditioned to the underlying data described by, for example, a data dictionary.

The example shown in FIG. 3A illustrates a planning page 300 through which a user may view information relevant to compensation planning process. The planning page consists of several elements, such as tabs 310A-E, and rollbars 320 A-C. Details for an individual employee's compensation package may be presented in rollbars, such as rollbars 320A-C. In this example, the details for one of the employees identified in the team-level view are further set forth in the rollbars 320A-C as shown on planning page 300. The rollbar views provide a fine grained view of components that may go into an individual employee's compensation package and may allow the reviewing user to, for example, make adjustments to those elements of the compensation package and/or review information related to the compensation plan, as appropriate.

For example, the illustration of FIG. 3A shows components involved in computing a subject employee's base pay as may be displayed after selection of base pay tab 310A. Of course, the use of tabs is purely arbitrary and other visual indicators may be used in their place. Similar details can be provided for other components of the employee's compensation, such as bonus information, stock information, performance information, and employee profile information. Rollbar(s) 310A-C may include a hyperlink. A hyperlink may be associated with information related to the compensation plan such that selection of the hyperlink initiates the action of providing the information associated with the hyperlink. The information may then be, for example, displayed to a user, such as user 140, via, for example, a presentation module, such as presentation module 130. A hyperlink may be indicated on a display, such as rollbar(s) 310A-C, as underlined text. For example, rollbar 310A includes the exemplary hyperlinks for base pay, house rent allowance, medical allowance, conveyance allowance, social allowance, and cost to company.

Components of base pay (and other compensation package factors) displayed within rollbars 310A-C may be governed by, for example, the enterprise and country-specific rules for determining that employee's compensation. So, for example, a compensation plan for an employee based in India may include compensation in the form of a housing rental allowance, a medical allowance, a conveyance allowance, and a special allowance, in addition to base pay. Compare that with the example shown in FIG. 3B, which illustrates compensation factors for an employee based in France. Here, only base pay and a 13^{th} month allowance are included in the compensation plan for the employee. This ability to provide, for example, enterprise and/or government specific compensation factors on a per-employee basis within the view templates may be made possible by the use of configurable compensation rules.

The compensation planning tool may be integrated with a repository of information or database concerning, for example, compensation factors, practices, policies, and benefits for employees working in countries throughout the world. This repository of information may be referred to as a Global Rewards Library, and in one embodiment it is a database storing detailed explanations of the various compensation terms and rules which a user and/or manager may encounter during a compensation planning event. If desired, enterprise-specific, work group-specific, and/or employee-type specific practices, policies and benefits may be added to the database as well.

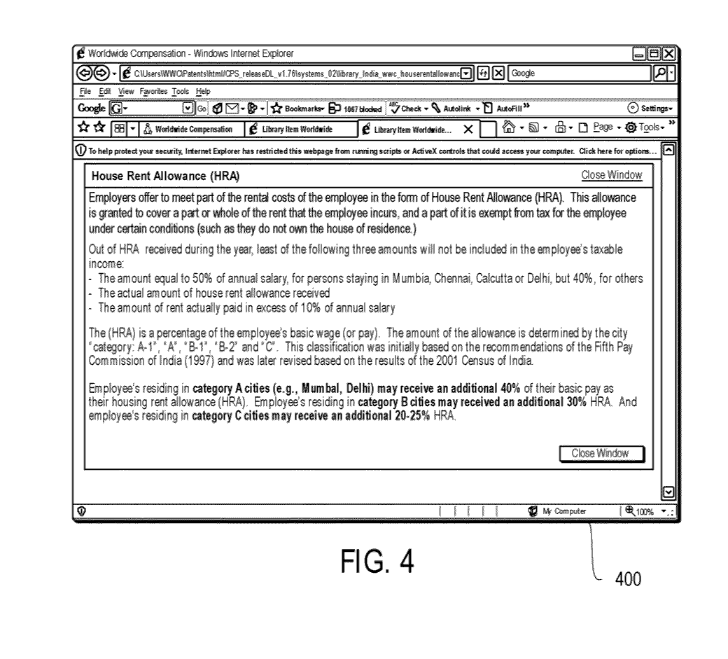

For example, above it was noted that for the employee working in India, a house rent allowance may be provided. A user based in, for example, the United States, may not be familiar with the concept of a house rent allowance or understand how that allowance relates to an individual's compensation. By selecting, for example, a hyperlink and/or icon associated with the house rent allowance term in rollbar 320A, a user can view information regarding the house rent allowance, as shown in FIG. 4.

In this example, the information concerning the house rent allowance may be displayed in, for example, a separate window (e.g., a pop-tip window) 400 in the user's browser. In other instances, the information may be presented in different formats, or may even be sent to the user as another form of communication, such as an e-mail message or instant message, etc. For the illustrated case, the compensation planning application may include a web service interface to the Global Rewards Library and/or database, which allows for the display of pop-up windows in the conventional fashion. As indicated, users of the compensation planning system may choose to record enterprise-specific details regarding their compensation practices in the Global Rewards Library and/or database. In this way, the Global Rewards Library and/or database may become a system of record in defining the compensation planning process for the enterprise.

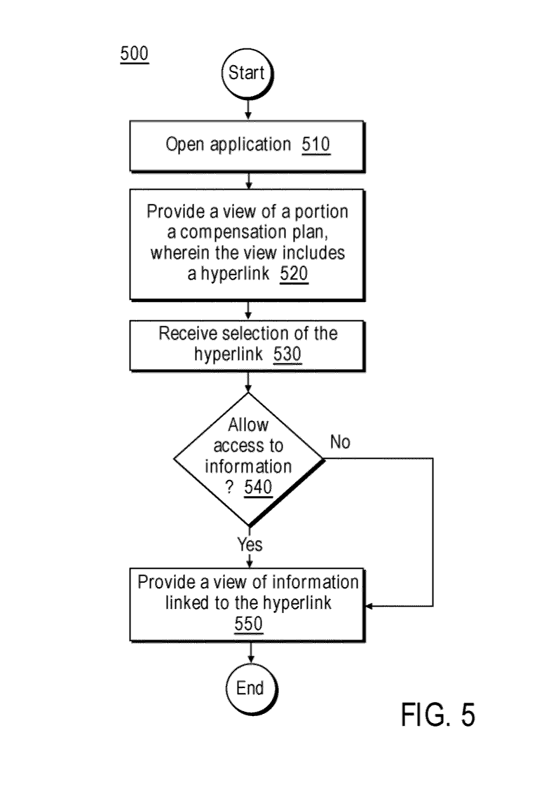

FIG. 5 illustrates a process 500 for providing information related to a compensation plan for an enterprise. Process 500 may be performed by, for example, system 100 and/or the application described by architecture 200. Process 500 may be initiated by, for example, a user, such as user 140.

In step 510, an application for compensation planning, for example, application 150 may be opened. The application may be enabled to provide information related to a compensation plan for an enterprise. The application may be resident in, for example, a server, such as server 120. The application may display the compensation plan and/or information related to a compensation plan to a user, such as user 140, via, for example a presentation module (such as presentation module 130) using, for example, a view template provided by, for example, the view template module.

In step 520, a view of a portion of the compensation plan may be provided. The view may include an hyperlink and the hyperlink may be associated to information related to, for example, the compensation plan or a compensation benefit or factor within the compensation plan. In step 530, a selection of the hyperlink may be received from, for example, a user, such as, user 140. Selection of the hyperlink may initiate the action of providing information associated with the hyperlink. The provided information may be, for example, displayed to a user, such as user 140, via, for example, a presentation module, such as presentation module 130. The information may be displayed as, for example, a pop-up window, a text box, or a page. An exemplary view of the provided information is shown in FIG. 4. Additionally or alternatively, the information may be provided via, for example, a message, email, and/or instant message.

In step 540, it may be determined whether a user is allowed to access the information associated with the selected hyperlink. Such a determination may be made by, for example, verifying a user's identity or verifying a user's compliance with a security protocol. The security protocol may be included in, for example, the application. If access is denied, then process 500 may end. If access is allowed then a view of information associated with the hyperlink may be provided (step 550). The provided information may be searchable via, for example, a search engine included in the application or an external search engine.

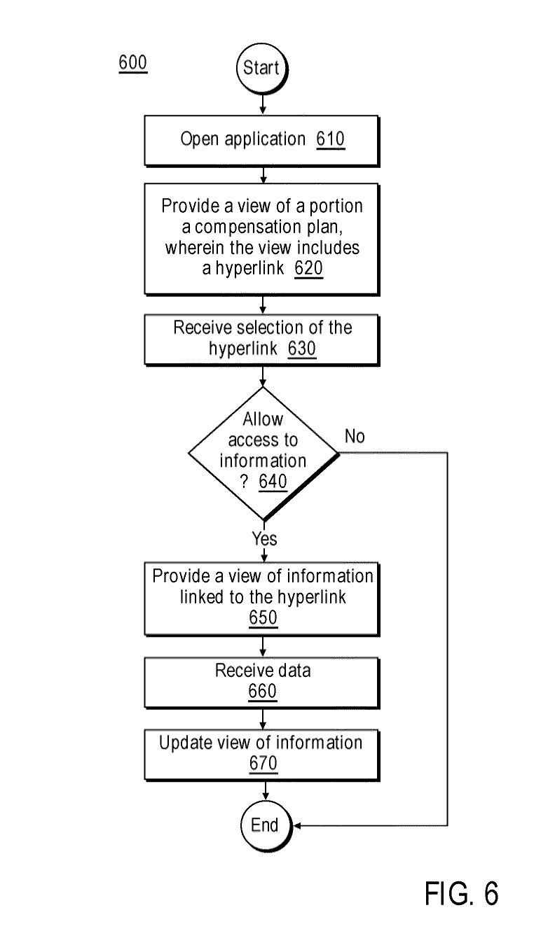

FIG. 6 illustrates a process 600 for receiving data by a view of information related to a compensation plan of an enterprise. Process 600 may be performed by, for example, system 100 and/or the application described by architecture 200. Process 600 may be initiated by, for example, a user, such as user 140.

In step 610, an application for compensation planning, for example, application 150 may be opened. The application may be enabled to provide information related to a compensation plan for an enterprise. The application may be resident in, for example, a server, such as server 120. The application may display the compensation plan and/or information related to a compensation plan to a user, such as user 140, via, for example a presentation module, such as presentation module 130 using, for example, a view template provided by, for example, the view template module.

In step 620, a view of a portion of the compensation plan may be provided. The view may include an hyperlink and the hyperlink may be associated to information related to, for example, the compensation plan or a compensation benefit within the compensation plan. In step 630, a selection of the hyperlink may be received from, for example, a user, such as, user 140. Selection of the hyperlink may initiate the action of providing information associated with the hyperlink. The provided information may be, for example, displayed to a user, such as user 140, via, for example, a presentation module, such as presentation module 130. The information may be displayed as, for example, a pop-up window, a text box, or a page. An exemplary display of the provided information is shown in FIG. 4. Additionally or alternatively, the information may be provided via, for example, a message, email, and/or instant message.

In step 640, it may be determined whether a user is allowed to access the information associated with the selected hyperlink. Such a determination may be made by, for example, verifying a user's identity or verifying a user's compliance with a security protocol. The security protocol may be included in, for example, the application. If access is denied, then process 600 may end. If access is allowed then a view of information associated with the hyperlink may be provided (step 650). The provided information may be searchable via, for example, a search engine included in the application or an external search engine.

Data may be received (step 660) from a user, for example, user 140. The view of the information may then be updated using, for example, the received data (step 670) and process 600 may end.

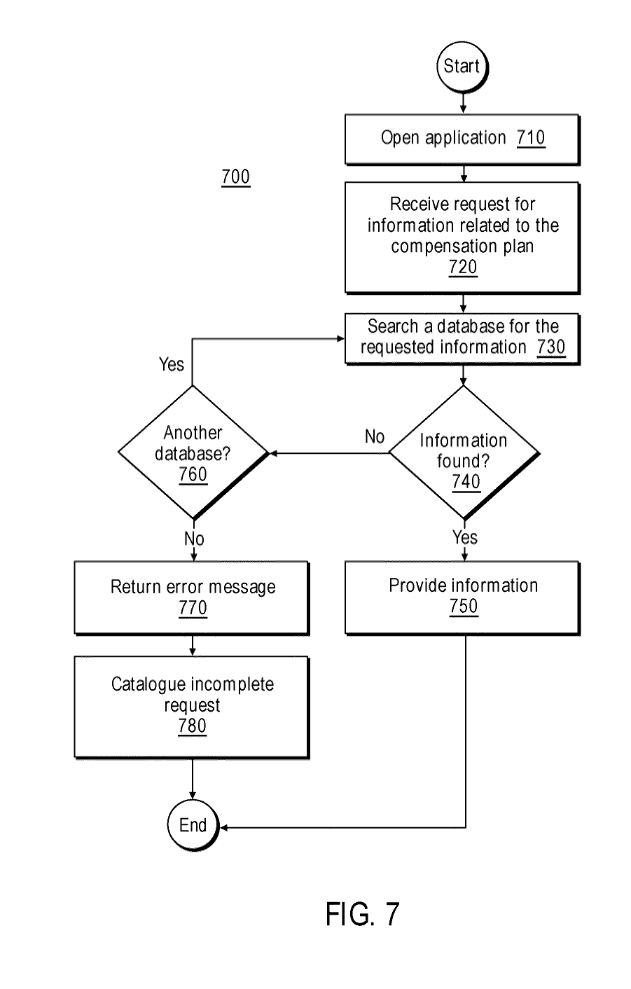

FIG. 7 illustrates a process 700 for providing information related to a compensation plan of an enterprise. Process 700 may be performed by, for example, system 100 and/or system architecture 10. Process 700 may be initiated by, for example, a user, such as user 140.

In step 710, an application for compensation planning, for example, application 150 may be opened. The application may be enabled to provide information related to a compensation plan for an enterprise. The application may be resident in, for example, a server, such as server 120. The application may display the compensation plan and/or information related to a compensation plan to a user, such as user 140, via, for example a presentation module such as presentation module 130 using, for example, a view template provided by, for example, the view template module.

In step 720, a request for information related to a compensation plan of an enterprise may be received from, for example, a user, such as user 140. The request may be transmitted via, for example, selection of a hyperlink. Following receipt of the request, a database may be searched for the requested information (step 730). In step 740, it may be determined whether the requested information is found. When the requested information is found, it may be provided via, for example, the application, as a view, via, for example, presentation module 130 (step 750) and process 700 may end.

If the information is not found, then it may be determined whether there is another database (step 760). If there is another database to search, then steps 730 and 740 may repeat themselves. If there is not another database to search then an error message may be returned to the requester (step 770). The incomplete request may also be catalogued (step 780) and process 700 may end.

Thus, a platform configured to provide information related to a compensation plan for workforces that may be made up of large numbers of geographically dispersed employees has been described.

What is claimed is:

1. A method for providing information related to a compensation plan for an enterprise, the method comprising:
opening an application for compensation planning;
providing, via the application, a view of a portion of the compensation plan, wherein the view includes a hyperlink and the hyperlink is associated with information related to the compensation plan,
receiving a selection of the hyperlink; and
providing a view of the information associated with the hyperlink.

2. The method of claim 1, wherein the view of the information associated with the hyperlink is capable of receiving data, the method further comprising receiving data, via the view of the information associated with the hyperlink.

3. The method of claim 2, further comprising updating the information associated with the hyperlink using the received data.

4. The method of claim 1, wherein the information related to the compensation plan is stored separately from the application for compensation planning.

5. The method of claim 1, wherein the information associated with the hyperlink is provided via at least one of a view, a message, an email, and an instant message.

6. The method of claim 1, wherein the information related to the compensation plan is stored in a global rewards library.

7. The method of claim 6, further comprising searching the global rewards library for the information.

8. The method of claim 1, further comprising determining whether a user is allowed to access the information.

9. The method of claim 1, wherein the information related to the compensation plan is related to a compensation benefit provided by the compensation plan.

10. The method of claim 1, further comprising receiving a request for data within the view of information related to the hyperlink; and searching the information according to the received request.

11. A graphical user interface (GUI), comprising:
means for displaying a view of a portion of a compensation plan, the view including a hyperlink associated with information related to the compensation plan;
means for receiving a selection of the hyperlink; and
means for displaying information retrieved in response to selection of the hyperlink, the information being retrieved from a data store separate from a compensation planning application providing the GUI.

12. The GUI of claim 11, further comprising means for receiving data via a view of the information retrieved in response to selection of the hyperlink.

13. The GUI of claim 12, further comprising means for updating the information retrieved in response to selection of the hyperlink using the received data.

14. The GUI of claim 12, further comprising means for receiving a request for data within the view of information retrieved in response to selection of the hyperlink; and displaying the data responsive to the received request.

15. A computer readable storage medium having stored thereon computer-readable instructions, which instruction when executed by a processor cause the process to perform a method, comprising providing, via an application for compensation planning, a view of a portion of a compensation plan, wherein the view includes a hyperlink and the hyperlink is associated with information related to the compensation plan; and provide, in response to receipt of a selection of the hyperlink, a view of the information associated with the hyperlink.

16. A system, comprising a compensation planning application executing on a computer platform; a presentation module providing a view of a portion of a compensation plan determined by the compensation planning application, the view developed by the compensation planning application and including a hyperlink associated with information related to the compensation plan; and a global rewards library accessible to the computer platform in response to selection of the hyperlink.
